(19) United States
(12) Patent Application Publication
(10) Pub. No.: US 2008/0048457 A1
(43) Pub. Date: Feb. 28, 2008

(54) Hydraulic energy conversion system

(76) Inventors: Bhanuprasad S. Patel, Peoria, AZ (US); Unang Bhanuprasad Patel, Peoria, AZ (US)

Correspondence Address: ROBERT W PITTS, PO BOX 11483, WINSTON-SALEM, NC, 27116-1483, US

(21) Appl. No.: 11/636,051

(22) Filed: Dec. 8, 2006

Related U.S. Application Data
(60) Provisional application No. 60/840,259, filed on Aug. 28, 2006.

(51) Int. Cl. F03D 9/00; B60K 16/00; F01B 23/10

(52) U.S. Cl. 290/1 R; 180/2.2; 60/698

(57) ABSTRACT

An energy conversion device includes batteries and a DC motor. A rotary member is driven by a hydraulic pump, which acts through pistons engaging a eccentric U-shaped rod to impart torque to the rotary member. Bevel gears transfer the torque to the rotary member, which can be connected to a DC generator or a battery charger. The pistons include hollow piston head and piston rods, which reduce the amount of hydraulic fluid that must be pumped. This energy conversion device may be employed in a vehicle, which may also employ a windmill as an auxiliary power source. Air is outlet from this windmill through hollow rotating windmill arms and through a hollow central shaft.

### CROSS REFERENCE TO PRIOR CO-PENDING APPLICATION

This application claims the benefit of prior co-pending Provisional Patent Application Ser. No. 60/840,259 filed Aug. 28, 2006.

### BACKGROUND OF THE INVENTION

This invention relates to an energy conversion device and more particularly to a hydraulic apparatus for use in an electrical system. The electrical system can include a motor for driving a workpiece, which could comprise a vehicle that is at least in part powered by the batteries.

### SUMMARY OF THE INVENTION

The present invention relates to an energy conversion system that is utilized to convert the energy from a bank of batteries to a form of energy that can be utilized by a work piece such as a gear assembly or a wheel and axle assembly. Basically, the energy conversion system includes one or more batteries connected in series. The output voltage of the batteries is directed to a controller, which is in turn operatively connected to a DC motor. The controller effectively controls the speed of the DC motor. The DC motor in turn is connected to a gearbox, which, in turn, may be connected to a work piece such as a wheel and axle assembly.

The energy conversion system of the present invention also includes a DC generator. The DC generator is operatively connected to a battery charger for powering the same and the battery charger is in turn connected to the one or more batteries for recharging the batteries.

In one embodiment, there may be provided a rotary fluid drive operatively connected between the one or more batteries (or another battery) and the DC generator. In such an embodiment, the power outputted by the one or more batteries or the battery charger is utilized to drive a fluid pump, which in turn drives a rotor or rotary assembly. The output of the rotary assembly is directed to the DC generator and functions to drive the same.

The present invention also entails an external power source that may be in various forms. The external power source is coupled to the one or more for providing energy or power, either continuously or on demand, to recharge the one or more batteries.

The rotary fluid drive also includes a series of pistons acting eccentrically on a U-shaped rod to deliver torque to the rotary member. This U-Shaped rod imparts rotation to a driving bevel gear, which then imparts rotation to a shaft driving the rotary member through a driven bevel gear mounted on the shaft.

The pistons can employ hollow piston heads and hollow piston rods so that a smaller amount of fluid must be pumped during reciprocation of the pistons than would be required if fluid were to be pumped into and out of a cylinder containing pistons of the same cross sectional area as those employed herein.

When used on a moving vehicle this energy conversion system may be combined with a windmill or wind turbine mounted on the vehicle and acting as an auxiliary source of power. An air stream imparts rotation to the windmill and air is exhausted through hollow windmill arms communicating with a rotating hollow shaft, which supplies torque to the system.

### BRIEF DESCRIPTION OF THE DRAWINGS

FIG. 1 is a schematic illustration of the energy conversion system of the present invention.

FIG. 2 is a more detailed schematic illustration of the energy conversion system of the present invention.

FIG. 3 is a schematic illustration of the rotary fluid drive that forms a part of the energy conversion system.

FIG. 4 is a schematic sectional view showing the structure of one head of the rotary fluid drive.

FIG. 5 is a view of the hydraulic pistons and the U-shaped rod that drive bevel gears to develop torque to drive the rotary member attached to the DC generator or battery charger.

FIGS. 6A and 6B are views of alternate versions of piston/cylinder subassemblies that can be employed in this invention, and the manner in which they operate.

FIG. 7 is a side view of the windmill or wind turbine.

FIG. 8 is a view showing the windmill or wind turbine and the air inlet through which air flows to engage the rotary turbine subassembly.

FIG. 9 is a schematic showing the manner in which batteries may be charged by employing a positive drive belt between the shaft and a battery charging device.

FIG. 10 is a schematic showing the manner in which the shaft can be connected to a gearbox by a positive drive belt.

### DESCRIPTION OF PREFERRED EMBODIMENT OF THE INVENTION

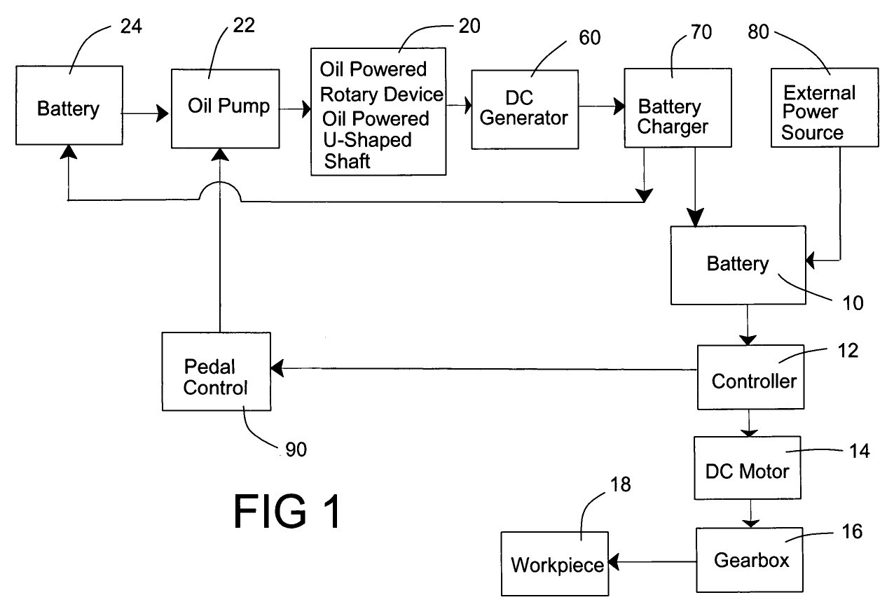

With further reference to the drawings, particularly FIG. 1, the energy conversion system of the present invention is schematically shown therein. The energy conversion system includes one or more batteries 10. In one embodiment, this includes eight 12-volt batteries connected in series. The bank of batteries 10 is in turn connected to a controller 12. Controller 12 is connected to a DC motor 14. The controller effectively controls the speed of the DC motor. Details of the controller are not dealt with herein because such is not per se material to the present invention and further, such controllers for controlling the speed of the DC motor are well known and appreciated by those skilled in the art. Controller 12 is of the type manufactured by Zapi Inc. under the model No. H2. The Zapi H2 controller is a microprocessor-based controller for motors.

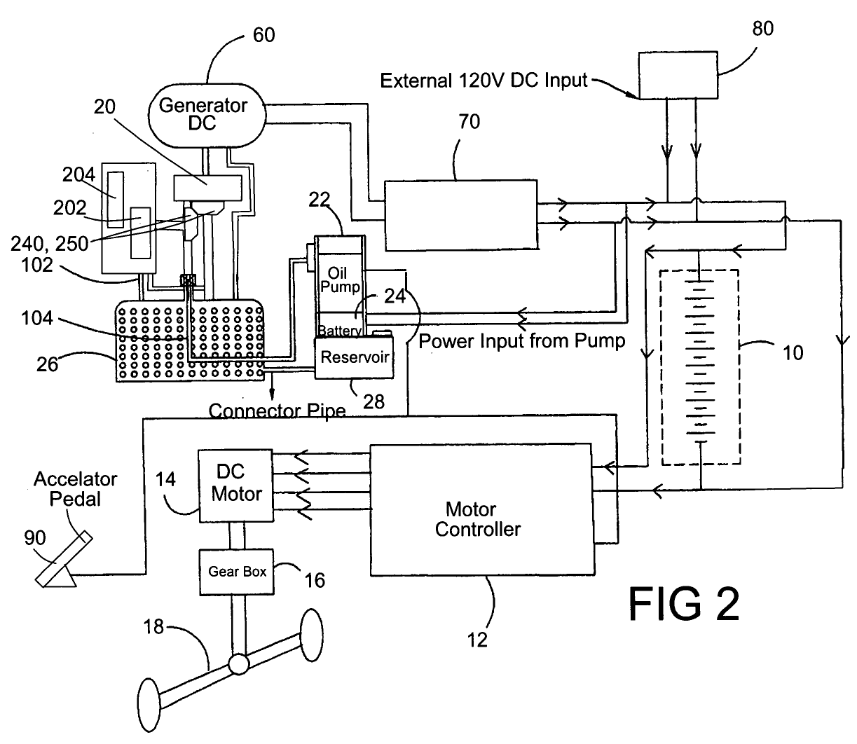

The DC motor 14 is operatively connected to a gearbox 16. The driving torque associated with the DC motor 14 is transferred to the gearbox 16. The gearbox 16 is in turn operatively connected to a work piece 18. Work piece 18 may assume various forms. In FIG. 2, the work piece 18 is simply a wheel and axel assembly such as found on a vehicle.

There is also provided a rotary power drive. As illustrated in FIG. 1, the rotary power drive includes an oil powered rotary device 20, an oil pump 22 and a battery 24. Battery 24 powers the oil pump 22, which in turn drives the rotary device 20. In the embodiment of FIG. 1, a separate battery or bank of batteries 24 is utilized to drive the oil pump 22. However, it should be appreciated that the battery or bank of batteries 10 could be utilized to drive the oil pump 22. In the embodiment illustrated in FIG. 1, the battery charger 70 is operatively connected to the battery 24 for charging the same.

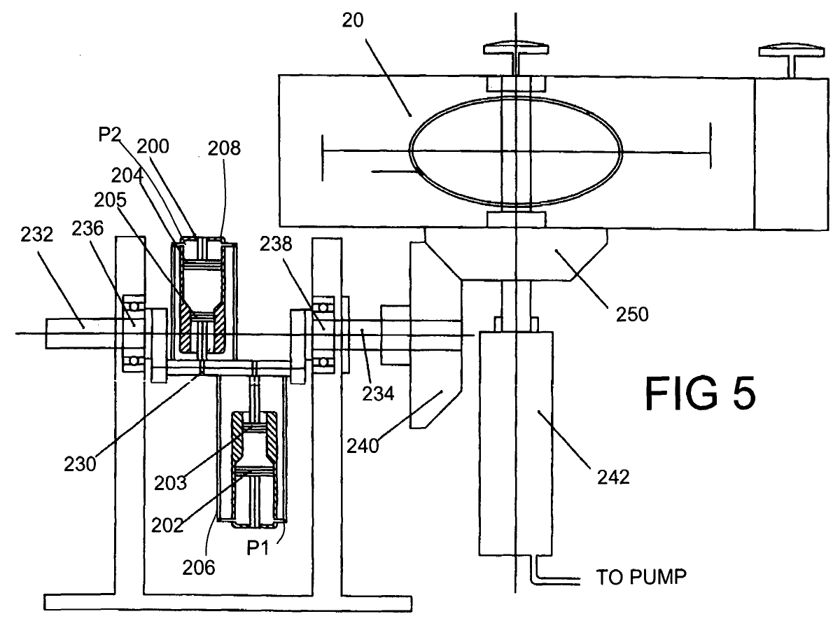

The rotary fluid drive includes, as seen in FIG. 2, a main tank 26 and a pump reservoir 28. Main tank 26 is adapted to contain and hold oil that is pumped by the oil pump 22 to the rotary device 20. Reservoir 28 is specifically adapted to be interposed between the tank 26 and the oil pump 22. That is, in pumping oil from the tank 26, oil is pumped through the pump reservoir 28, and through the pump into the rotary device 20. Subsequently with respect to FIG. 5, the rotary fluid drive or rotary device and the applying torque to the rotary device will be discussed in more detail. The output of the rotary fluid drive is connected to a DC generator 60. Although the size of the DC generator may vary, it is anticipated that in one embodiment, the same would be a 30 horsepower DC generator and would, under certain conditions, turn approximately 3600 rpm.

DC generator 60 is operatively connected to a battery charger 70. The output of the DC generator 60 basically powers the DC battery charger. The battery charger would have a capacity to charge a bank of batteries comprised of eight 12-volt batteries. In order to supply power to the system just described, there is provided an external power source indicated by the numeral 80. External power source 80 could be in various forms but which would be ultimately adapted to provide DC power to the battery or bank of batteries 10. To control the energy conversion system shown in FIGS. 1 and 2, there is provided an actuator or control indicated by the numeral 90. In the case of the embodiment shown in FIG. 1, this actuator or control is in the form of a pedal control such as an accelerator. The actuator or control 90 is connected to the controller 12 and to the oil pump 22 which would include an associated motor for driving the same.

Referring back to the rotary fluid drive, as seen in FIG. 2 the rotary fluid drive includes a housing 100. A pair of drain lines 102 extends from the housing 100 to the tank 26. Further, there is provided an inlet line 104 that extends from the oil pump 22 into the housing 100. As will be discussed below, oil pumped by the oil pump 22 is directed into the housing 100 where the oil acts to drive a rotary assembly that is rotationally mounted in the housing 100.

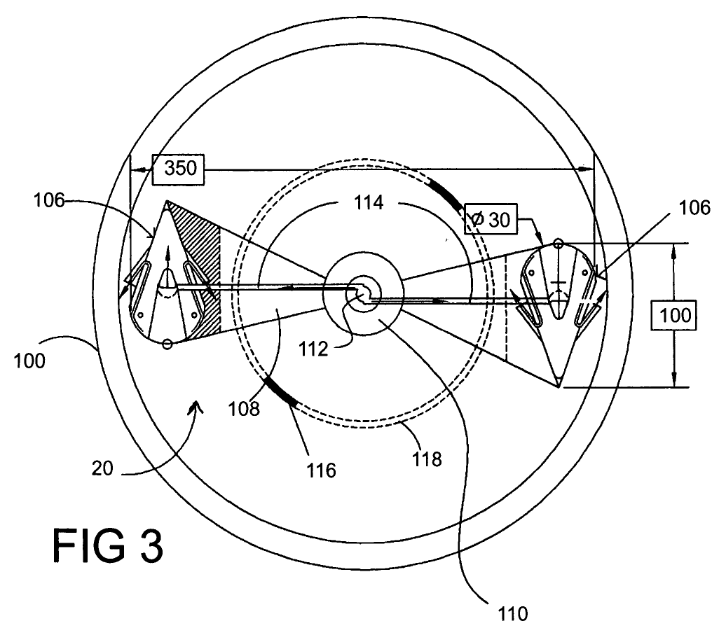

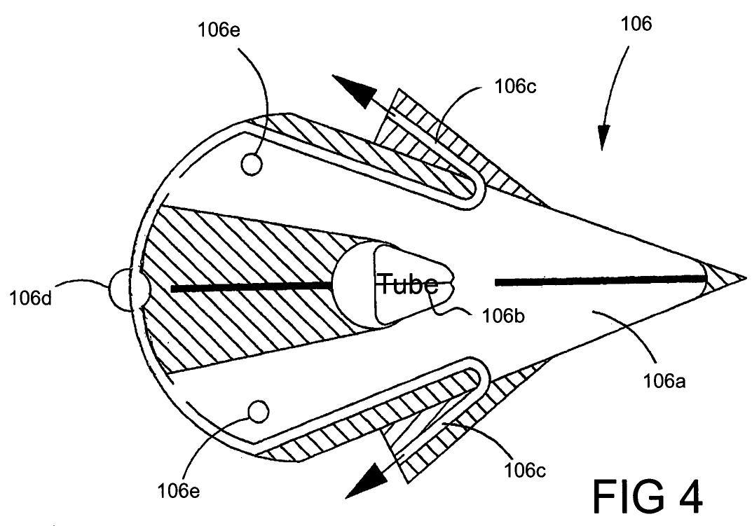

Turning to FIGS. 3 and 4, the rotary drive is shown in schematic form. The rotary drive in this design or embodiment includes a pair of heads, with each head indicated generally by the numeral 106. The heads 106 are mounted on a rotary member 108 that is rotationally mounted with shaft 110. There is provided an oil inlet 112 disposed interiorly of shaft 110. The rotary member 108 supports or includes a pair of feed lines 114 that extend from adjacent the oil inlet 112 into each of the heads 106. There is also provided a bearing wheel 116 and a track 118 for the bearing wheel. The bearing wheel and track enables the heads 106 and the rotary member 108 to turn in a relatively smooth manner.

An auto clutch may be disposed between the rotary fluid drive and the DC generator. Such a clutch can be of a conventional clutch design and is adapted to control the torque transferred from the rotary fluid drive to the DC generator 60. Details of the oil inlet 112 and its relationship to the inlet lines 114 are not dealt with here in detail because structures that are capable of supporting the function required here are well known. That is, the oil inlet 112 is capable of supplying oil under pressure from the oil pump 22 continuously around the oil inlet 112. That is, as the rotary member 108 turns, the individual lines 114 leading to the heads remain communicatively connected to the oil inlet 112 such that oil can be passed from the oil inlet into the respective lines 114.

The hydraulic pump drives a plurality of pistons, which transfer torque to a rotary device to drive a DC generator. In the preferred embodiment as shown in FIG. 5, two pistons reciprocate in corresponding cylinders to drive a U-shaped rod. It should be understood that additional torque can be generated by adding more pistons driving U-shaped rods in a manner similar to a crankshaft. As shown herein, the U-shaped rod is mounted in bearings on opposite sides of the U-shaped link, which is offset from the axis of rotation of the portion of the rod extending through the bearings. Torque generated by the movement of pistons within corresponding cylinders is transferred thorough bevel gears to cause rotation of the rotary member, which in turn drives the DC generator.

Hydraulic pressure is applied to a piston/cylinder assembly 200 including pistons 202 and 204 in opposed cylinders 206 and 208 so that the pistons 202 and 204 move in opposite directions. Hydraulic pressure is applied trough ports P1 and P2, which communicate with the hydraulic pump, through lines that are not shown in the schematic of FIG. 5. When hydraulic pressure is applied to piston 202, this piston is forced upward along with follower piston 203. The follower piston 203 is attached to the U-shaped rod or link 230, causing the U-shaped rod 230 to rotate about the axis of the portions 232 and 234 of the rod extending through the bearings 236 and 238 and attached at the center of rotation of the driving bevel gear 240. The connecting piston rod on the follower piston 203 can also pivot relative to the U-shaped rod 230 to which it is attached. When one piston rod 202 reaches the position in which the U-shaped rod 230 has rotated 180° relative to the position shown in FIG. 5, this piston 202 has reached the limit of its upward travel. A valve is opened so that hydraulic pressure can then be forced out of the piston/cylinder through port P1. At the same time pressure is applied to the piston 204 in the opposed cylinder 208 through port P2. A downward force will then be applied to the U-shaped rod 230. Continued application of pressure to the piston 204 causes piston 204 and follower piston 305 to move downward and cause the U-shaped rod 230 to continue to rotate in the same direction. A constant torque will then be applied to the driving bevel gear 240 as long as the hydraulic pump continues to apply a constant hydraulic pressure to the pistons 202 and 204. The driving bevel gear 240 will then transfer this torque to the driven bevel gear 250 imparting rotation to the rotary member 20. The mechanical advantage attributable to the lever arm provided by the U-shaped rod 230 allows greater torque to be applied than would be possible by applying pressure directly to the rotary member 20.

The hydraulic pressure driving the pistons 202 and 204 is also applied to the rotary member 20. Oil or hydraulic fluid is pumped through the rotating shaft 248 on which the driven bevel gear 250 is mounted. The oil or hydraulic fluid is pumped to the rotating member 20 and is expelled through the rotating member is the direction opposite direction of rotation. The rotating member 20 shown in U.S. Pat. No. 6,856,033, incorporated herein by reference, can be employed. The same hydraulic pump will supply pressure to the pistons 202 and 204 as well as to the rotating member 20. In other words the same hydraulic pressure will be acting on each member. The rotating member 20 will rotate in unison with the driven bevel gear 250 and the jet caused by expelling pressurized fluid through the ends of the rotating member 20 will be equivalent to reducing the rotational inertia on which the torque supplied by pistons 202 and 204 through the U-shaped rod 230 will act. As seen in FIG. 5 a flexible line 246 extending from the hydraulic pump transmits oil under pressure through the cylindrical bearing 242 and through the hollow shaft 248 to the rotary member 20.

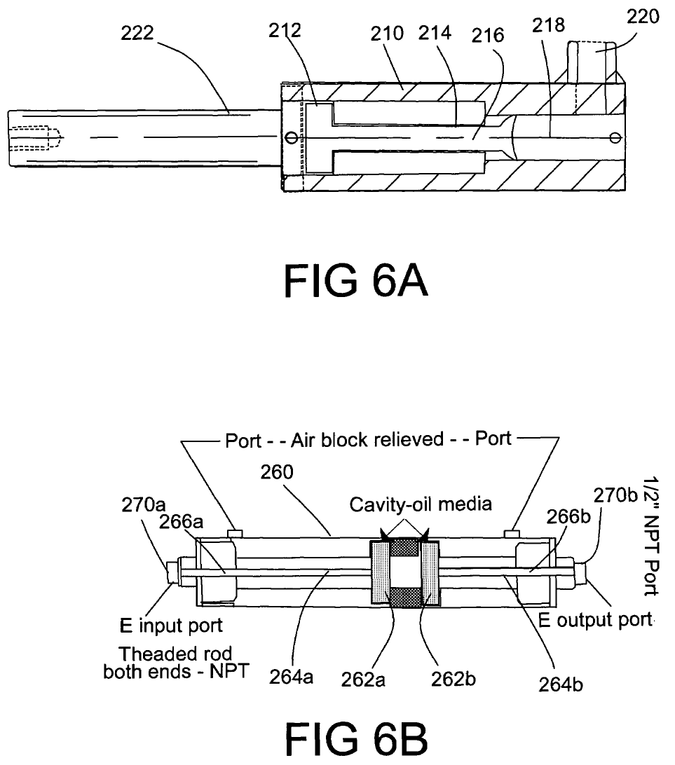

FIGS. 6A and 6B show two alternate versions of hydraulic piston/cylinder subassemblies that can be employed to drive and rotate the U-shaped rod 230 and to drive the driving bevel gear 240 through the shaft 234. FIG. 6A shows a version in which a single piston 212 is mounted in a cylinder 210. At least two separate cylinders 210 and pistons 212 will be need to drive U-shaped rod 230. A force is delivered to piston 212 only on its forward stroke, so each piston 210 can drive the U-shaped rod 230, only during half of each single revolution. Thus two pistons 212, in corresponding cylinders 210, will be opposed to each other in the manner generally shown in FIG. 5.

Each piston 212 has a hollow head that communicates with the hollow interior 216 of the corresponding piston rod 214. Hydraulic fluid is introduced into chamber 218 through port 220, and the increased pressure will act on the interior face of the head of the piston 212. In FIG. 6A, this piston 212 is shown at the maximum extent of its travel. Movement of piston 212 to this position has caused rod 222 to also move to the maximum extent of its travel. Rod 222 would be connected to U-shaped link 230. Assuming piston 212 is acting in a downward direction as shown in FIG. 5, the position in FIG. 6A represents the position associated with the position of the U-shaped rod 230 as shown in Figure. When the piston 212 reaches the position shown in FIG. 6A, hydraulic pressure acting on the piston head 212 will be reduced, allowing the piston 212 to return to its position of minimum travel, corresponding to the position that it would occupy if employed in the upwardly acting piston in FIG. 5.

Among the advantages of this piston/cylinder assembly are the fact that the time for activating the pistons and moving them within the corresponding cylinders is significantly reduced because of the relatively small amount of fluid that must be pumped. The piston cavity will never completely drain, saving fill-up time and energy. The volume of this piston cavity is always less than a corresponding conventional cylinder, thus eliminating the extra time needed to fill up the traditional cylinder. The back thrust when a dimensionally comparable conventional cylinder is employed will be greater than the back thrust when this invention is employed, thus improving efficiency.

Unlike a conventional piston, the hydraulic pressure acting on piston head 212 will act on the entire area of the piston head 212, which will essentially correspond to the internal area of the cylinder 212. In a conventional piston, the increased hydraulic pressure will act only on the portion of the piston head surrounding the piston rod, since the hydraulic fluid, and the hydraulic pressure would act in the cavity between the cylinder walls and the piston rod. In one example of this invention, a 3.5 inch piston would have an surface area of 9.621 square inches. Applying a pressure of 600 psi to this surface area will result in a force of 5,772.6 lbs. This would be the force generated by the piston. For a conventional cylinder in which the entire cylinder would include the hydraulic pressure and the piston would include a rod, then the cross sectional area of the rod would have to be subtracted. The surface area of a 1¼ inch rod would be 1.227 square inches, and this area must be subtracted from the surface area of the piston, because the hydraulic pressure would not act on this area. If a pressure of 600 psi were applied to a 3.5 inch piston connected to a 1¼ inch rod, the resulting force would be 5036.4 lbs, significantly less than the force that would be generated with the instant invention. Assuming then that the 5,772.6 pounds of force were applied to a U-shaped rod 230, offset from the axis of the shaft by 1½ inches, a torque equal to the product of the force and the moment arm or offset of the U-shaped rod would be developed. This would be a torque of 8658.9 inch pounds

The alternate configuration shown in FIG. 6B shows two pistons 262a and 262b acting in opposite directions within a single cylinder 260. Each piston is connected to a corresponding hollow piston rod 264a or 264b with hydraulic fluid communicating though the hollow centers 266a and 266b to the hollow heads of pistons 262a and 262b. Ports 270a and 270b act as both input ports and output ports. When port 270a acts as an input port to increase pressure on piston 262a, port 270b acts as an output port to release pressure acting on piston 262b. Otherwise the configuration shown in FIG. 6B acts in the same way as that shown in FIG. 6A and has the same advantages. Only one of these double acting piston/cylinder subassemblies will be needed to impart rotation to the driving bevel gear 240 through the U-shaped rod 230, because a positive output force will be delivered by one of the pistons 262a or 262b at all times.

FIG. 4 shows details of the rotary member 20 to which torque developed by the piston/cylinder assembly is delivered through bevel gears 240, 250. With particular reference to the head 106, attention is directed to FIG. 4. In FIG. 4, the head 106 is shown to include an internal cavity 106a. Cavity 106a is adapted to receive a supply of oil under pressure. That is, the oil in cavity 106a will be at a pressure greater than atmospheric pressure. Disposed generally between the front and rear portions of each head 106 is an inlet 106b that allows oil to be directed into the cavity 106a. There is also provided a pair of outlet ports or orifices 106c. Oil under pressure within the cavity 106a is expelled out these outlet ports 106c in a jet-like fashion. Because of the substantial high pressure of the oil exhausted out of ports 106c, the heads 106 are propelled in a clockwise direction as viewed in FIG. 3. That is, as the oil is expelled out ports 106c, there is backward thrust generated causing the heads 106 to be driven, Further, there is provided a central outlet port or orifice 106d about the rear end of each head. Although not shown, there is an oil channel from the cavity 106a to the central outlet port 106d. Finally, there is provided in the oil cavity 106a two pressure relief valves 106e that permit the release of oil from the cavity 106 in the event of a pressure build-up greater than a pre-determined value. The pump will continue to deliver oil to the head and maintain the oil within the head under a pressure greater than atmospheric pressure. As noted above, when the oil is expelled from the orifices or ports, the velocity will give rise to a backward thrust to the head. Oil expelled from the heads 106 drains down into the housing 100 and therefrom through the drain lines 102 back to the main tank 26. Although the hydraulic pistons and cylinders shown in FIGS. 6A and 6B provide certain advantages, it should be understood that a conventional hydraulic piston and cylinder assembly can be employed.

The rotary member 20 is mounted on the same shaft 242 on which the driven bevel gear 250 is mounted. Rotary member 20 will not only supply additional torque to drive shaft 242, but will act to cool the oil ejected from the heads 106.

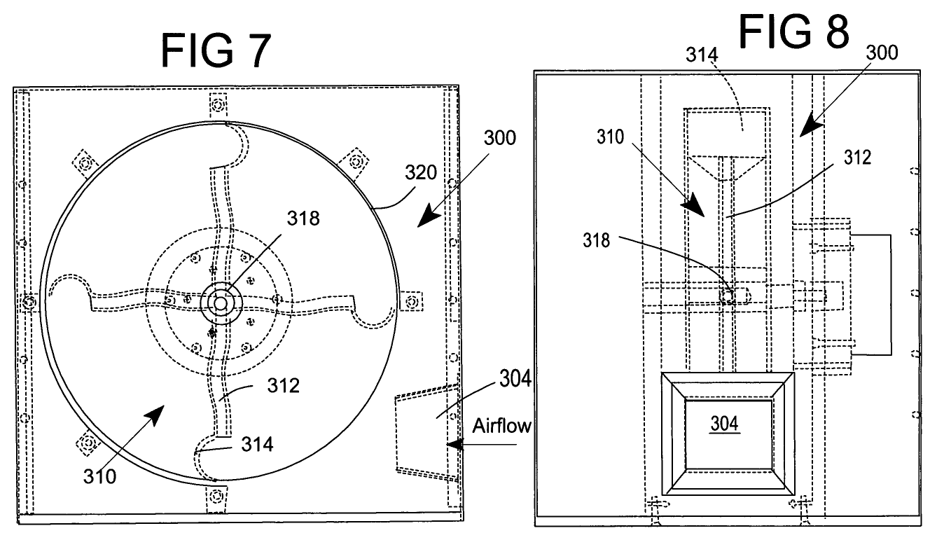

FIG. 7, shows a windmill or turbine 300 that can be mounted on a moving vehicle to develop an auxiliary torque. This device converts the energy that results from air impacting the windmill or turbine 300 to drive the DC generator 60 which in turn powers the battery charger 70. As noted above, battery charger 70 is operatively connected to the one or more batteries referred to by the numeral 10.

The preferred embodiment of this windmill or wind turbine 300 comprises a rotor assembly 310 including a series of radially extending arms 312 mounted and rotating with a central shaft 318. This rotor subassembly 310 is mounted in an outer housing 302, which includes an air inlet 304, which will face forward as the vehicle on which it is mounted moves relative to stationary air. The inlet 304 is offset relative to the centerline of the housing 302 so that the relative movement of air into the housing 302 strikes only a rotating arm 312 that is in general alignment with the air inlet 304.

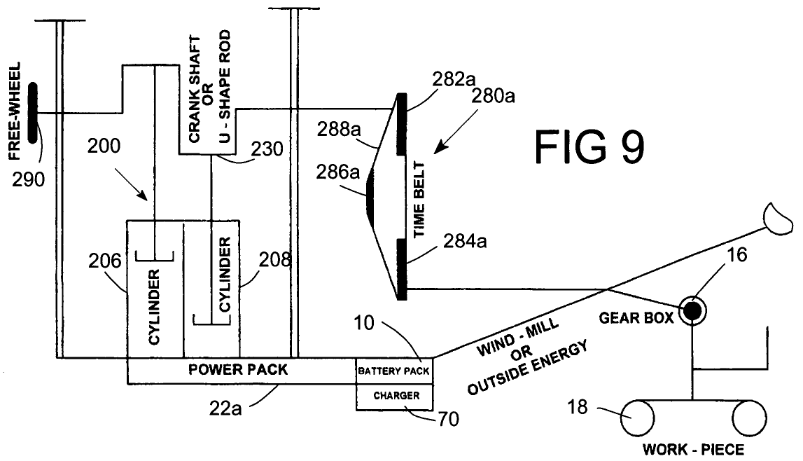

Each of the arm 312 includes a collector 314 at its distal end. These collectors 314 can be in the from of cups or scoops that can be semi-hemispherical, cylindrical or generally concave so as to gather or temporally trap air as it moves through the air inlet 304. As best seen in FIG. 8, the collector 314 employed in the preferred embodiment is a simple configuration comprising a cylindrical member that can be formed from a simple flat metal sheet. Of course this collector 314 could also be molded or fabricated by other means. This cylindrical member 314 is mounted on an arm formed from a hollow tube, which will expose less frontal area to the inlet airflow than exposed by the cylindrical collector 314.

The air striking the cylindrical collector 314 will result in a force, primarily centered in the cylindrical collector 314, that will act about an moment arm, substantially equal to the length of the arm 312, to cause the rotor subassembly 310 to rotate about its center of rotation. The center of rotation is coincident with the axis of the central shaft 318 and rotational movement of the arm 312 gathering air at the inlet will cause the shaft to rotate as well. Since most of the force is generated at the end of the arm 312, this results in a relatively large moment arm or lever so that the amount of torque will be relatively large for the size of the entire windmill or turbine assembly 300.

In the embodiment depicted herein, the rotor subassembly 310 rotates in a clockwise direction, although it should be understood that a similar assembly rotating in the counterclockwise direction would be equally effective. In either case, rotation of the rotor subassembly 310 will sequentially bring the cylindrical collectors 314 on the other arms 312 into alignment with the air inlet 304 resulting is a substantially constant torque applied through the rotor to the generator or battery charger to which the shaft 318 is connected.

A cylindrical shell 320 surrounds the rotor subassembly 310 around three quadrants of the rotation of the windmill or turbine. This cylindrical shell 320 is mounted in the housing 300, and the only open quadrant is the one generally aligned with the air inlet 304. As air flows through the inlet 304, it will be collected within the cylindrical shell 320 resulting in a stagnation pressure greater than the ambient air pressure. The air outlet for this apparatus is through the rotating hollow shaft 318. The hollow tubes forming the arms 312 communicate with this hollow shaft 318 and the air pressure is greater at the distal end of this shaft 318, adjacent the cylindrical collector 314. Thus air will flow radially inward through these hollow tubes into the hollow shaft 318, and it will then be expelled though an air outlet, not shown, located at the opposite end of the shaft 318. A vacuum pump may be employed to enhance the flow of air in this direction. Air expelled from this outlet can then be employed to air cool the energy conversion apparatus. The air inlet 304, as shown in FIGS. 7 and 8 can also extend over most if not all of the front face of this assembly.

Although the cylindrical shell 320 and the rotor subassembly are shown in FIGS. 7 and 8 mounted in a rectangular outer housing 302, it should be understood that the rectangular configuration of this housing 302 is merely representative. This windmill or wind turbine 300 can be mounted at various locations on the moving vehicle. The outer surface of the vehicle, will normally be streamlined, and therefore the drag, which would result from exposure of a rectangular housing would not be encountered when this assembly is mounted in a moving vehicle.

This windmill is merely representative of an external power source that may be employed with this system. Other external power sources, such as an internal combustion engine or other conventional power sources, could also be employed.

The torque supplied by the pistons to the U-shaped rod 230 can be delivered directly to the gearbox 16 to drive the work piece 18 by using a belt to connect the gearbox 16 to the output shaft 234.

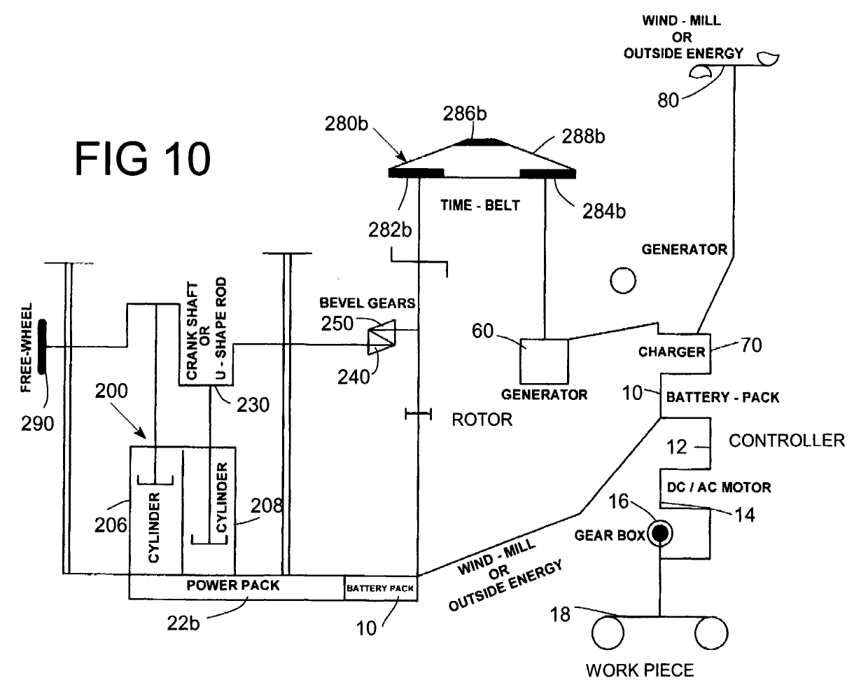

FIGS. 9 and 10 show two alternate means for driving a workpiece 18 by using components of the energy conversion device of this invention. After a discussed of each of these two schematic, the manner of combining the mechanical and electrical drive mechanisms shown in FIGS. 9 and 10 will be discussed.

FIG. 9 shows a mechanical drive mechanism in which the output of the two hydraulic cylinders 206 and 208 driver the U-shaped rod 230, which is in turn connected to gear box 16 to drive the work piece 18. A free wheel or fly wheel is mounted on the opposite end of the U-shaped rod 230 for stability. A positive drive belt assembly 280a, which can alternately be referred to as a timing belt or a synchronous belt, is employed to transmit rotation of the U-shaped rod 230 to gear box 16. This positive drive belt assembly 280a includes a belt 288a connected to a drive pulley 282a, which is driven by the U-shaped drive rod or shaft 230. A driven pulley 284a, which is also mounted on the belt 288a drives a rod attached to gearbox 16. A tensioner or stretcher pulley 286a can be shifted to insure that the belt 288a securely engages both the drive pulley 282a and the driven pulley 284a. Positive drive belt 288a, as is common with these types of belts, has evenly spaced teeth (not shown) on its interior surface, and these teeth mesh with teeth on the pulleys to produce a positive, no-slip transmission of power.

The pistons in cylinders 206 and 208 are driven by a power pack 22a, which includes a hydraulic pump and an oil reservoir. A charger 70 charges a battery pack 10, and the charger 70 is in turn driven by an outside energy source, such as a windmill. The windmill is not directly connected to the gear box, although the line from the windmill to the charger 70 does intersect the shaft extending between the driven pulley 284a and the gearbox 16, in the schematic of FIG. 9. However, these are merely schematic lines and are not intended to represent a mechanical connection.

FIG. 10 is another schematic showing the manner in which the hydraulically driven cylinder assembly 200 can be interconnected to a generator 60 by a positive drive belt assembly 280b. The pistons in cylinders 206 and 208 are driven by a hydraulic pump, which along with an oil reservoir, comprises the power pack 22b. The output of the shaft 230 is transmitted to a rotor shaft through meshing bevel gears 240 and 250 in the manner that was previously discussed. Positive drive belt assembly 280b includes a drive pulley 282b driven by the shaft rotated by the driven bevel gear 250. Driven pulley 284b is in turn mounted on a shaft driving the generator 60. Tensioner pulley 286b can be adjusted to insure positive engagement of the positive drive belt 288b to the pulleys 282b and 284b. In this configuration, the output of the U-shaped shaft 230 can be employed to store the battery pack or a series of batteries 10, which can alternatively be powered by an outside energy source 80, such as a windmill.

The schematics of FIGS. 9 and 10 are not incompatible, since both positive drive belt assemblies 280a and 280b can be incorporated into the same apparatus. Appropriate clutch means (not shown) can be employed to activate either drive belt assembly as appropriate for specific operating conditions. Thus the work piece 18 may either be driven directly by mechanical means, as shown in FIG. 9, or by electrical means, as shown in FIG. 10.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein

1. An energy conversion device comprising:
at least one battery;
a rotary member driving a generator to charge the at least one battery:
a motor driven by the at least one battery charged by the generator;
a hydraulic pump;
at least one piston driven by the hydraulic pump, the piston eccentrically driving a rod to rotate the rod, the rod being connected through gears to the rotary member so that the torque delivered by the pistons to the rotary member is increased by the lever arm due to the eccentrically driven rod.

2. The energy conversion device of claim 1 wherein the piston is connected to a U-shaped rod, the point of attachment to the U-shaped rod being eccentrically offset relate to the center of rotation of the rod connected to the gears.

3. The energy conversion device of claim 2 wherein the rod drives a first drive bevel gear, which drives a driven gear mounted on a shaft imparting rotation to the rotary member.

4. The energy conversion device of claims 1 wherein a series of pistons are offset relative to the rod driving the gears.

5. The energy conversion device of claim 1 wherein each piston comprises a piston head mounted on a hollow piston rod acting as a piston connecting rod, hydraulic fluid being present in the piston head and in the hollow piston rod so that hydraulic pressure acts over the cross sectional area of the piston head.

6. The energy conversion device of claim 5 wherein each piston is mounted within a cylinder, the cross sectional area of the hollow piston rod being less than the cross sectional area of the cylinder and the cross sectional area of the piston head being substantially the same as the cross sectional area of the cylinder.

7. The energy conversion device of claim 1 wherein the rotary member drives the generator through a positive drive belt.

8. The energy conversion device of claim 1 including a positive drive belt transferring force from the at least one piston to a gearbox for imparting motion to a workpiece.

9. The energy conversion device of claim 1 wherein the rotary member comprises an oil cooling apparatus.

10. The energy conversion device of claim 1 including a windmill comprising an alternate means for driving the generator.

11. An assembly comprising at least one piston reciprocating within a cylinder, each piston comprising:
a hollow piston head mounted on a hollow piston rod communicating with the hollow piston head, the volume of the piston head being less than the volume of the cylinder;
a valve communicating with the hollow piston rod, the piston rod permitting inflow and outflow of hydraulic fluid as hydraulic pressure acting on the piston is increase and decreased, inflow and outflow of hydraulic fluid as pressure is respectively increased and decreased being limited to the volume of fluid in the hollow piston head and the hollow piston rod to reduce the amount of fluid that must be pumped as the piston reciprocates in the cylinder.

12. The assembly of claim 11 wherein a pair of pistons are located in the cylinder.

13. The assembly of claim 12 wherein valves on hollow piston rods act as input and output vales as the pistons move in opposite directions within the cylinder.

14. The assembly of claim 11 wherein hydraulic pressure acts on the entire cross sectional area of the hollow piston head without interference by a piston rod, so that the output force is equal to the hydraulic pressure times the cross sectional area of the piston head.

15. The assembly of claim 11 wherein a piston is attached to a U-shaped rod at a point offset from the axis of rotation of the rod, wherein the torque developed about the axis of rotation of the rod is equal to the product of the pressure applied to the piston, the surface area of the piston and the distance of the offset of the point of attachment of the piston to the U-shaped rod and the axis of rotation of the rod.

16. A windmill for use in generating torque in a moving vehicle, the windmill comprising:
a housing cavity;
arms rotating about a shaft within the housing cavity;
a collector mounted on the end of each arm to increase the surface area impinged by an air stream entering the windmill;
wherein the arms and the shaft are hollow leading to an air outlet so that air may be exhausted from the housing cavity.

17. The windmill of claim 16 wherein a cylindrical shell extends partially around the rotating arms and shaft.

18. The windmill of claim 16 wherein the collectors include a concave surface.

19. The windmill of claim 18 wherein an air inlet is oriented so that the concave surface faces an air stream entering the air inlet.

20. The windmill of claim 16 wherein an air outlet is oriented so that air expelled therefrom will cool other components of the moving vehicle.
